(19) United States
(12) Patent Application Publication
(10) Pub. No.: US 2012/0194410 A1
(43) Pub. Date: Aug. 2, 2012

(54) Display System and Display Method

(75) Inventor: Maine Morimoto, Kawasaki-shi (JP)

(73) Assignee: Konica Minolta Business Technologies, Inc., Tokyo (JP)

(21) Appl. No.: 13/357,537

(22) Filed: Jan. 24, 2012

(30) Foreign Application Priority Data
Jan. 28, 2011 (JP) 2011-016867

(51) Int. Cl. G09G 5/00

(52) U.S. Cl. 345/1.1

(57) ABSTRACT

A display system equipped with an information management device (server 3) for offering centralized control of viewing restriction information indicating viewing restriction applicable to each display device (electronic paper device 1) ensures that if stored content in the information management device (server 3) of the viewing restriction information associated with each display device (electronic paper device 1) is updated, updated information indicating the viewing restriction information after being updated will be sent to each display device (electronic paper device 1) (S212), and the viewing restriction information retained in each display device (electronic paper device 1) will be updated with the updated information (S213).

### CROSS-REFERENCE TO RELATED APPLICATION

This application is based on Japanese Patent Application No. 2011-016867 filed on Jan. 28, 2011, the contents of which are incorporated herein by reference.

### BACKGROUND

1. Technical Field

The present invention relates to a display system including a display device such as an electronic paper device, and a display method performed by the display system.

2. Description of Related Arts

Electronic paper (or electronic book) has been actively developed in recent years as a new display medium replacing printing paper. The most popular display methods used for electronic paper available today include the electrophoresis method and the microcapsule method in which white and black charged particles contained in microcapsules are moved under an electric field so that black and white dots are switched. The positions of these charged particles remain stationary even after the electric field has been removed, and therefore the displayed contents stay unchanged until the time when they are rewritten. This feature makes people to believe that electronic paper will become an alternative display medium to printing paper (or a printed document).

In the case where electronic paper is used as a handout in an in-house meeting, there may be a need to impose viewing restrictions of the displayed contents of the electronic paper according to positions and ranks of the meeting participants (e.g. technical information restricted to the R&D department, personnel information restricted to the board members, etc.). In this respect, the Japanese Patent Publication No. 2007-172207 proposes an information management program which is capable of recognizing ID information of each electronic paper device via a data-transmission device, and generating output information to be displayed on the electronic paper device in accordance with the predefined procedure for each of the recognized ID information.

However, the aforementioned technology involves generation of image data according to the ID information of each electronic paper device, and therefore causes each electronic paper device to display a different content from each other if there are a number of electronic paper devices. The aforementioned technology also involves generation of new image data each time when a viewing restriction applicable to each electronic paper device has been revised. Therefore, the aforementioned technology entails an excessive system load as it involves generation and transmission of image data each time when a viewing restriction applicable to each electronic paper device has been revised.

### SUMMARY

In order to achieve at least one of the aforementioned objects, the display system according to the present invention comprising: a plurality of display devices for displaying an image based on document data, each of said display devices being subject to viewing restriction of each component of said document data; and an information management device for managing viewing restriction information indicating said viewing restriction applicable to each of said display devices.

Said information managing device comprises: a viewing restriction information storage unit for storing said viewing restriction information associated with each of said display devices; a first updating unit for updating stored content in said viewing restriction information storage unit of said viewing restriction information associated with each of said display devices, according to an instruction from administrator of said information management device; and an updated information sending unit for sending updated information indicating said viewing restriction information after being updated by said first updating unit.

Each of said display devices comprises: a viewing restriction information retaining unit for retaining said viewing restriction information associated with each of said display devices; a viewing restriction unit for restricting viewing of each component of said image to be displayed on each of said display devices, according to said viewing restriction information retained in said viewing restriction information retaining unit; an updated information receiving unit for receiving said updated information associated with each of said display devices sent from said updated information sending unit; and a second updating unit for updating said viewing restriction information retained in said viewing restriction information retaining unit, with said updated information received by said updated information receiving unit.

The objects, features, and characteristics of this invention other than those set forth above will become apparent from the description given herein below with reference to the preferred embodiment illustrated in the accompanying drawings.

### BRIEF DESCRIPTION OF THE DRAWINGS

FIG. 1 is a block diagram showing the structure of a display system according to an embodiment of the present invention.

FIG. 2 is a block diagram showing the structure of an electronic paper device according to an embodiment of the present invention.

FIG. 3 is a schematic illustration showing information retained in the electronic information retaining section of the electronic paper device according to an embodiment of the present invention.

FIG. 4 is a cross-section diagram showing the structure of a display unit of the electronic paper device according to an embodiment of the present invention.

FIG. 5 is a block diagram showing the structure of a multifunctional peripheral (MFP) according to an embodiment of the present invention.

FIG. 6 is a block diagram showing the structure of a control unit of the MFP according to an embodiment of the present invention.

FIG. 7 is a block diagram showing the structure of a server according to an embodiment of the present invention.

FIG. 8 is a schematic illustration showing a document file according to an embodiment of the present invention.

FIG. 9 is a schematic illustration showing a document file according to an embodiment of the present invention.

FIG. 10 is a schematic illustration showing a registration information management table according to an embodiment of the present invention.

FIG. 11 is a schematic illustration showing a viewing restriction information management table according to an embodiment of the present invention.

FIG. 12 is a schematic illustration showing a distribution status control table according to an embodiment of the present invention.

FIG. 13 is a schematic illustration showing document data according to an embodiment of the present invention.

FIG. 14 is a schematic illustration showing document data according to an embodiment of the present invention.

FIG. 15 is a sequence chart showing the processing executed by a PC, a MFP and a server according to an embodiment of the present invention.

FIG. 16 is a sequence chart showing the processing executed by an electronic paper device, a MFP and a server according to an embodiment of the present invention.

### DETAILED DESCRIPTION

One embodiment of this invention will be described below with reference to the accompanying drawings.

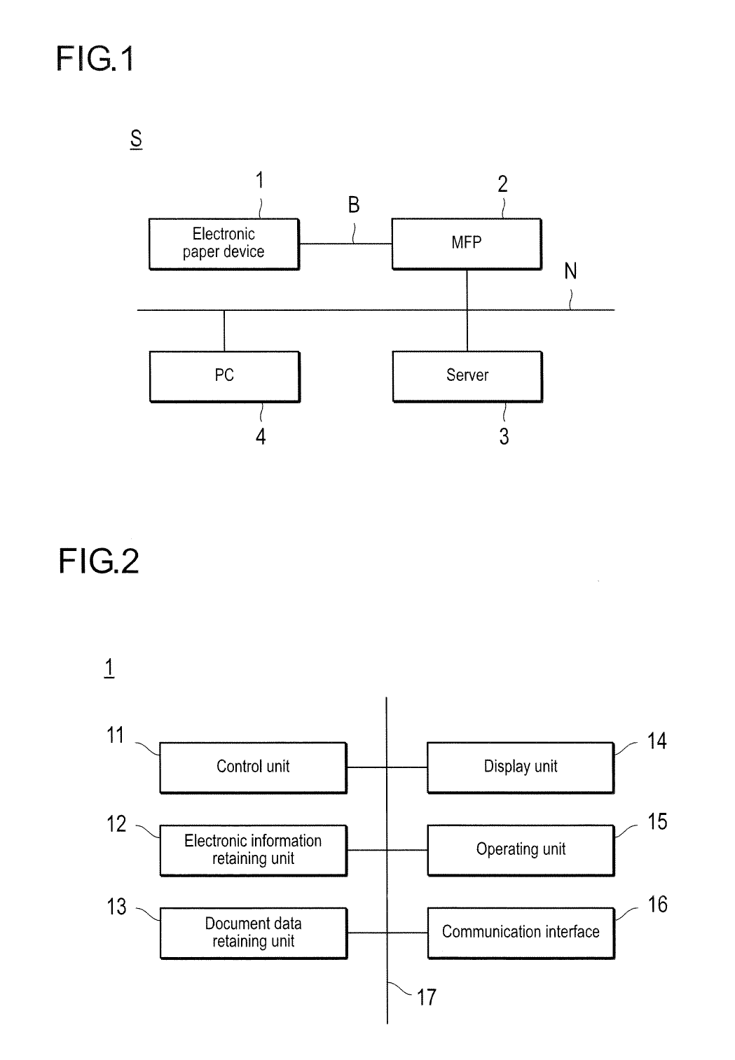

FIG. 1 is a block diagram showing the structure of a display system S according to an embodiment of the present invention. As shown in FIG. 1, the display system S comprises a plurality of electronic paper devices 1, each of which serves as a display device for displaying an image based on document data, a MFP 2 which serves as a data processing device for receiving a document file in a specific format to generated the document data, a server 3 which serves as an information management device for control ling various kinds of registered information associated with individual electronic paper devices 1, and a PC 4 which serves as a client for creating the document file to be sent to the MFP 2.

The MFP 2, the server 3, and the PC 4 are connected one another via a network N, while the MFP 2 and each electronic paper device 1 are locally connected with each other via a serial bus complying with a standard such as USB. A network N is a LAN complying with on a standard such as Ethernet (registered trademark), Token Ring, and FDDI, or a WAN consisting of a plurality of LANs connected one another via a dedicated line. The number and types of the devices connected to the network N are not limited to the example shown in the drawings.

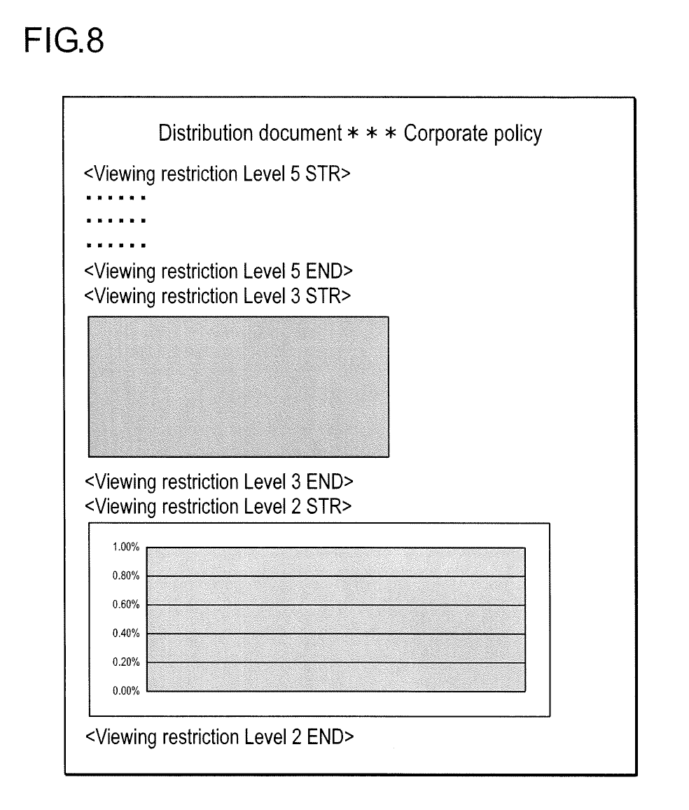

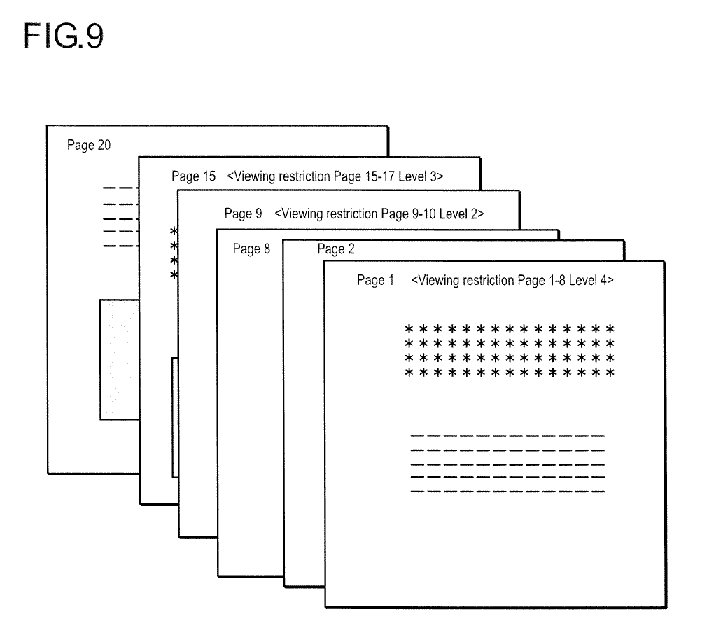

Details of the document file created by the PC 4 according to the present embodiment are shown below. FIG. 8 is a schematic illustration showing the document file according to the present embodiment. As shown in FIG. 8, each component (or object) of the document file is provided with tag information indicating the degree of viewing restriction expressed in multiple levels (e.g. “Level 0” to “Level 5”). A component with a viewing restriction level in a larger number is subject to severer viewing restriction. The actual viewing restriction applicable to each electronic paper device 1 in this embodiment is determined according to the aforementioned viewing restriction level. Details on the viewing restriction will be described later.

Unlike the example in FIG. 8 in which each object of the document file is provided with the tag information, each page of the document file can be provided with the tag information. FIG. 9 is a schematic illustration showing a document file in which each page is provided with the tag information. Moreover, unlike the examples in FIG. 8 and FIG. 9 in which tag information is included in the document file, the system can also be configured so that a dedicate software such as a printer derive prepares restriction commands separately from the document file.

Details of the components of each device are shown below. However, details of the PC 4 are omitted as the PC 4 is nothing but a general-purpose computer. FIG. 2 is a block diagram showing the structure of the electronic paper device 1 according to the present embodiment. As shown in FIG. 2, the electronic paper device 1 comprises a control unit 11, an electronic information retaining unit 12, a document data retaining unit 13, a display unit 14, an operating unit 15, and a communication interface 16, all of which are connected by a bus 17 for mutual communications. Details of each unit are shown below.

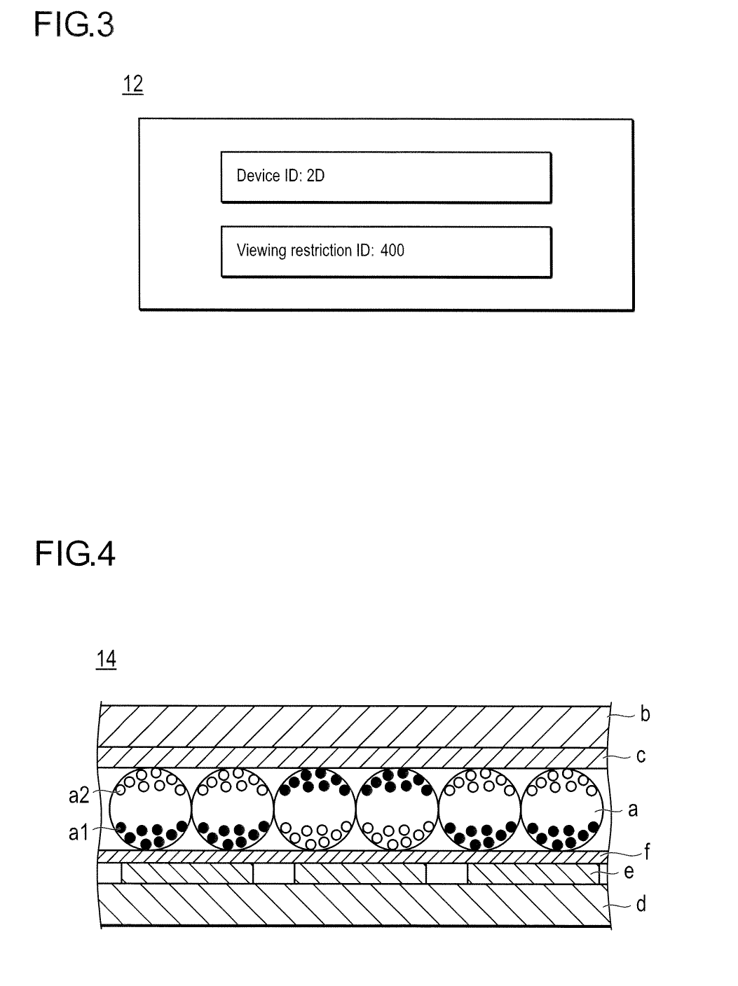

The control unit 11 is a central processing unit (CPU) for controlling the operation of each unit of the electronic paper device 1 according to various control programs. The electronic information retaining unit 12 is an auxiliary storage unit including a nonvolatile memory such as a flash memory and HDD for retaining various kinds of information concerning the relevant electronic paper 1. FIG. 3 is a schematic illustration showing the information retained in the electronic information retaining unit 12. As shown in FIG. 3, the electronic information retaining unit 12 retains a device ID (e.g. “2D”) which is an unique identification number to the relevant electronic paper device 1, and a viewing restriction ID (e.g. “400”) which is an identification code of the viewing restriction applicable to the relevant electronic paper device 1. Details on the viewing restriction ID will be described later.

FIG. 11 is a table showing correspondence relations between the individual viewing restriction IDs (i.e. “100” to “600”) and the aforementioned viewing restriction levels (i.e. “Level 0” to “Level 5”). As shown in FIG. 11, the electronic paper device 1 with the viewing restriction ID “300” is subject to viewing restriction of each data component with a viewing restriction level equal to or larger than Level 2, while the electronic paper device 1 with the viewing restriction ID “400” is subject to viewing restriction of each data component with a viewing restriction level equal to or larger than Level 3. The viewing restriction ID according to the present embodiment is associated with an user attribute of each electronic paper device 1. In the example of FIG. 11, the viewing restriction ID is “600”, “500”, “400”, “300”, “200”, and “100” if the user attribute of the electronic paper device 1 is “Board member”, “Manager”, “Research Section”, “Development Section”, “Subcontractor”, and “File Creator”, respectively. The correspondence relation as shown in FIG. 11 is prescribed in a viewing restriction information management Table T2, and this table is managed by the server 3 so that it can be retrieved by the MFP 2 as appropriate.

The document data retaining unit 13 is a data storage unit similar to the electronic information retaining unit 12 including a nonvolatile memory such as a flash memory and HDD for retaining document data to be displayed on the relevant electronic paper device 1. The present embodiment assumes that the document data retaining units 13 of all the electronic paper devices 1 retain the same document data.

The display unit 14 is a display panel for displaying an image based on the document data retained in the document data retaining unit 13. The structure of the display unit 14 will be described later in detail. The operating unit 15 is an input device such as a specialized keypad and forward/backward buttons for receiving various instructions from user. For example, the operating unit 15 is used to receive authentication information from user of the relevant electronic paper device 1. The communication interface 16 is an interface for communication with the MFP 2 via a serial bus.

FIG. 4 is a cross-section diagram showing the structure of the main part of the display unit 14 according to the present embodiment. As show in FIG. 4, the display unit 14 adopts the electrophoresis display method, and comprises micro-capsules “a” each containing negatively-charged black pigments “a1” and positively-charged white pigments “a2” encapsulated therein together with a transparent dispersion medium such as oil. The other elements shown in the diagram are described below.

The surface layer “b” is a front substrate made of a transparent material such as PET (Polyethylene Terephthalate) film, and the transparent electrode “c” made of a transparent electrically-conductive film such as ITO (Indium Tin Oxide) is placed on the rear surface of the surface layer. The support layer “d” is a rear substrate made of a material with insulating characteristics such as polyimide film, and the rear electrodes (or segment electrodes) “e” each comprising a minute metal plate corresponding to each micro-capsule “a”.

The aforementioned micro-capsules “a” are placed between the rear electrodes “e” and the transparent electrode “c”, and each micro-capsule “a” is bonded with one of the rear electrodes “e” via an adhesion layer “f”. Thus, a number of micro-capsules “a” are two-dimensionally arranged in a space between the front substrate (i.e. surface layer “b”) and the rear substrate (i.e. support layer “d”) via the two electrode plates “c” and “e” to form an effective display area of the display unit 14.

The following is a description of the displaying principle of the micro-capsules “a” arranged in the aforementioned manner. When the rear electrode “e” facing a micro-capsule “a” is subjected to a positive potential, the negatively-charged black pigments “a1” move toward the rear electrode “e” and the positively-charged white pigments “a2” move toward the transparent electrode “c” so that the relevant micro-capsule “a” looks white when being viewed from the front surface of the display area. Similarly, when the rear electrode “e” facing a micro-capsule “a” is subjected to a negative potential, the positively-charged white pigments “a2” move toward the rear electrode “e” and the negatively-charged black pigments “a1” move toward the transparent electrode “c” so that the relevant micro-capsule “a” looks black when being viewed from the front surface of the display area.

The electronic paper device 1 with the aforementioned structure has a function to restrict viewing of specified components of the document data in accordance with the viewing restriction ID retained in the electronic information retaining unit 12 while displaying an image on the display unit 14 based on the document data retained in the document data retaining unit 13. The wording “restrict viewing” herein means preventing the specified components of the document data from being viewed by user of the relevant electronic paper device by hiding these components or executing mask processing of these components.

FIG. 5 is a block diagram showing the structure of the MFP 2 according to the present embodiment. As shown in the diagram, the MFP 2 comprises a control unit 21, an electronic information retaining unit 22, a document data retaining unit 23, an image scanning unit 24, a printing unit 25, and a communication interface 26, all of which are connected by a bus 27 for mutual communications. Details of each unit are shown below.

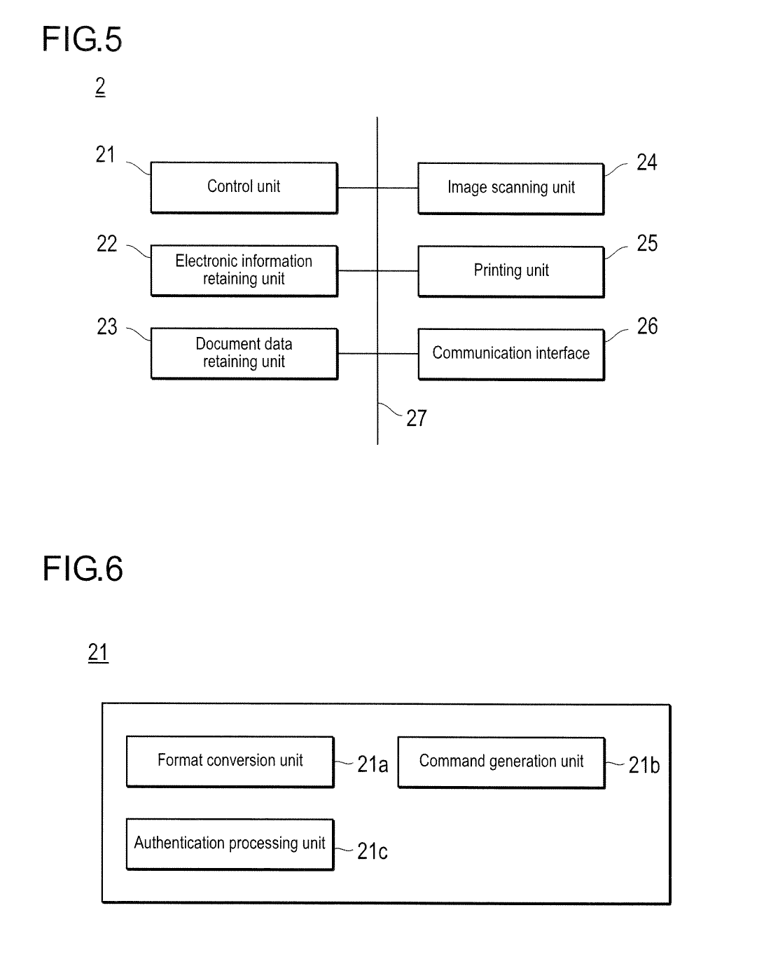

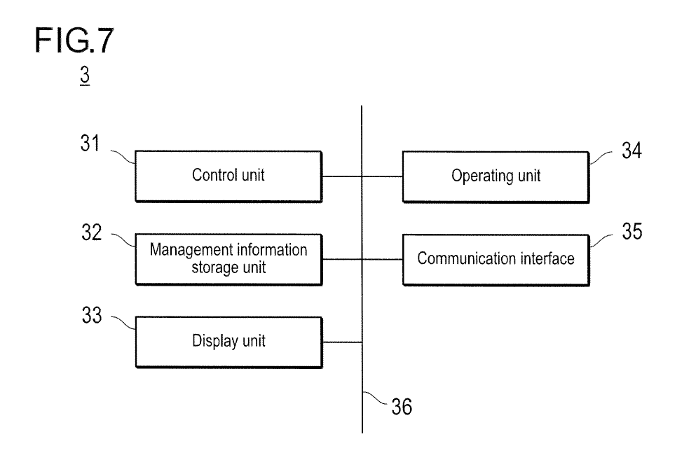

The control unit 21 is a central processing unit (CPU) for controlling the operation of each unit of the MFP 2 according to various control programs and executing various arithmetic operations. FIG. 6 is a block diagram showing the more detailed structure of the control unit 21. As shown in the diagram, the control unit 21 includes a format conversion unit 21a, a command generation unit 21b, and an authentication processing unit 21c. Details of each unit are shown below.

The format conversion unit 21a executes format conversion processing of the document file received from the PC 4 in order to generate document data to be handled by the electronic paper device 1. The command generation unit 21b translates the tag information (i.e. “Level 0” to “Level 5”) of each component of the document file into the viewing restriction ID (i.e. “100” to “600”) according the aforementioned viewing restriction information management table T2 in order to generate a viewing restriction command to be used for instructing the electronic paper device 1 to restrict viewing of each component.

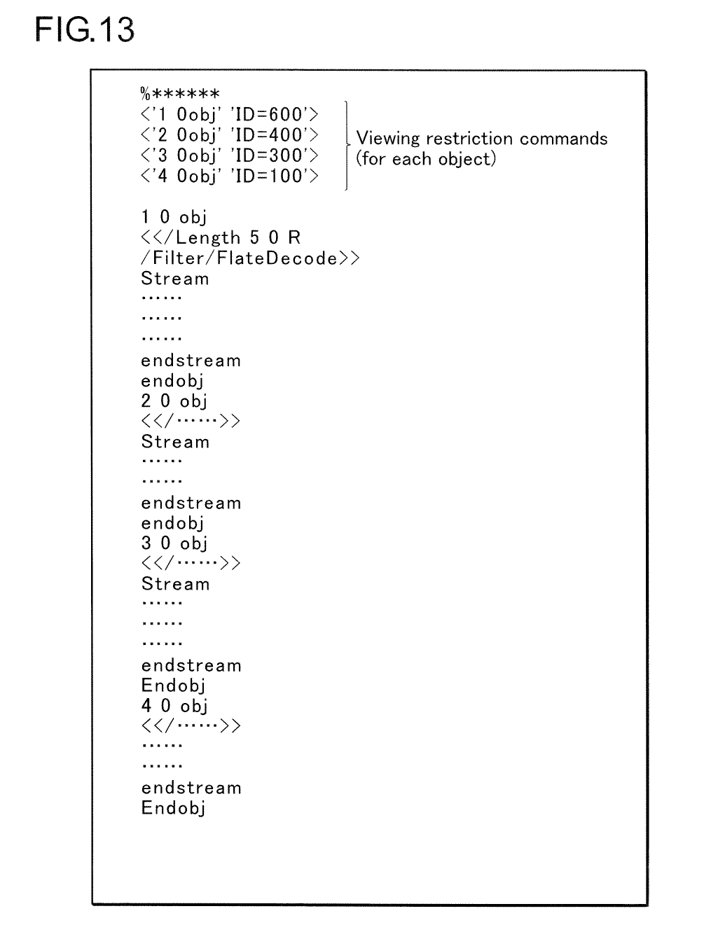

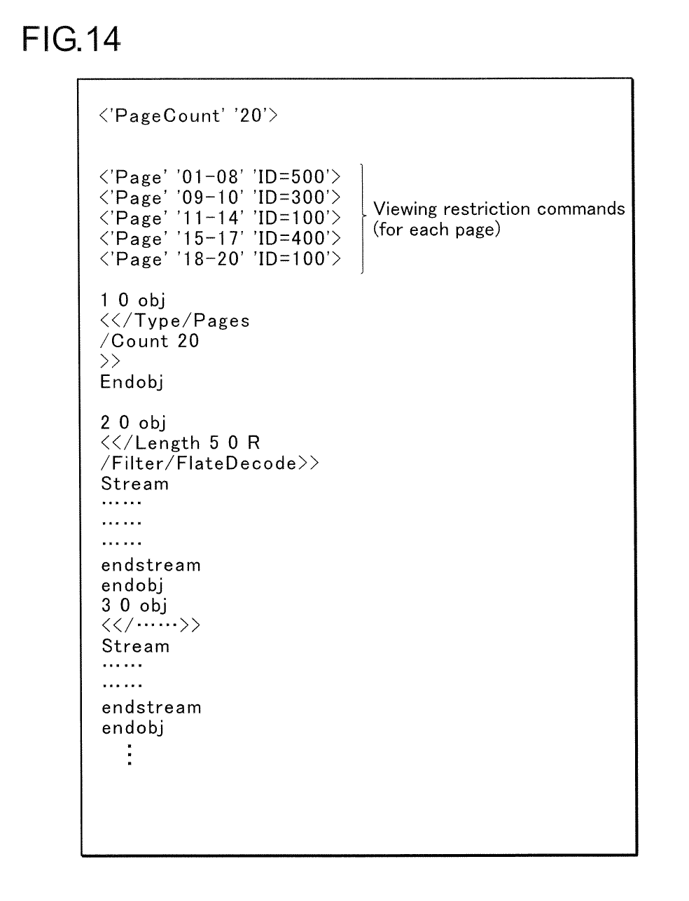

FIG. 13 is a schematic illustration showing the document data resulted from the processing by the format conversion unit 21a and the command generation unit 21b. The document data in this illustration corresponds to the document file shown in FIG. 8. The viewing restriction commands shown in this illustration form a list of the components (i.e. objects) of the document data, and each component (i.e. object) within the viewing restriction commands is provided with a viewing restriction ID (i.e. “100” to “600”) corresponding to its viewing restriction level (i.e. “Level 0” to “Level 5”). FIG. 14 is a schematic illustration showing the document data corresponding to the document file shown in FIG. 9. Each component (i.e. page) within the viewing restriction commands shown in this illustration is provided with a viewing restriction ID (i.e. “100” to “600”) corresponding to its viewing restriction level (i.e. “Level 0” to “Level 5”). In the case where the document data is color bitmap data (e.g. RGB bitmap data) or two-valued monochromatic bitmap data, the document data can be provided with a viewing restriction ID for each pixel, unlike the examples shown in FIG. 13 and FIG. 14 in which the document data is provided with a viewing restriction ID for each object and page, respectively.

With reference to FIG. 6 again, the authentication processing unit 21c determines whether or not the document creator and the user of the electronic paper device 1 should be authorized based on the authentication information received from the PC 4 and the electronic paper device 1. More specifically, the authentication processing unit 21c determines whether or not the file creator should be authorized by checking its authentication information received from the PC 4 with a predefined authentication information list. Similarly, the authentication processing unit 21c determines whether or not the user of the electronic paper device 1 should be authorized by checking its authentication information with a predefined authentication information list. Details on these operations will be described more in depth later.

Referring to FIG. 5 again, the document data retaining unit 23 is a non-volatile auxiliary storage unit such as HDD for retaining the document data resulted from the processing by the format conversion unit 2 la and the command generation unit 21b. The image scanning unit 24 is an image scanner which is capable of generating image data by irradiating either a document placed on a scanning position on the platen or a document transported to the scanning position by an ADE (Auto Document Feeder) with a light source such as a fluorescent lamp, and scanning the reflected light with light receiving elements such as CCD and CMOS image sensors.

The printing unit 25 is a print engine which is capable of printing an output image of the document data on a printer sheet, transparency film and the like, using the electro-photographic printing method. However, the printing unit 25 can also adopt other printing methods including the impact method, the thermal transfer method, and the ink-jet method. The communication interface 26 is a communication module such as NIC for executes communication processing with the server 3 and the other network devices via the network N as well as communication processing with the electronic paper device 1 via the external bus B.

FIG. 7 is a block diagram showing the structure of the server 3 according to the present embodiment. As shown in this diagram, the server 3 comprises a control unit 31, a management information storage unit 32, a display unit 33, an operating unit 34, and a communication interface 35, all of which are connected via bus 36 for exchanging signals. Details of each component are described below.

The control unit 31 is a central processing unit (CPU) for controlling the operation of each unit of the server 3 in accordance with various control programs and executing various arithmetic operations. The management information storage unit 32 is a nonvolatile storage unit such as HDD and the like for storing not only the aforementioned viewing restriction information management table T2 but also a registration information management table T1 for managing the registration information associated with each electronic paper device 1 and a distribution status management table T3 for managing the distribution status of the document data to each electronic paper device 1. Details of the registration information management table T1 and the distribution status management table T3 are described below.

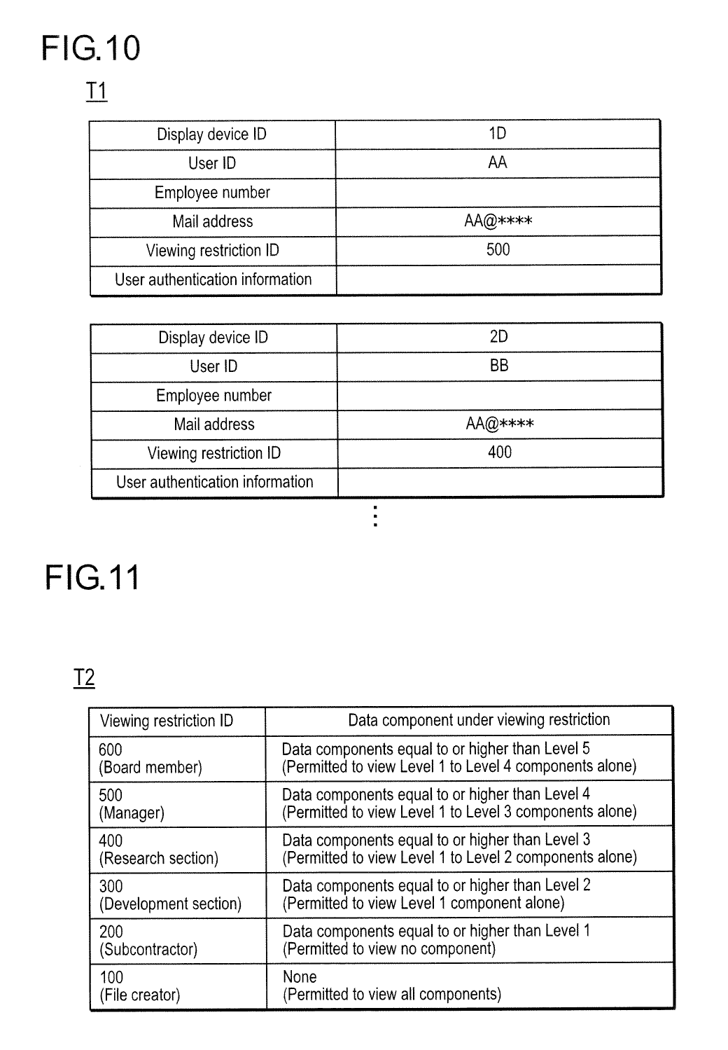

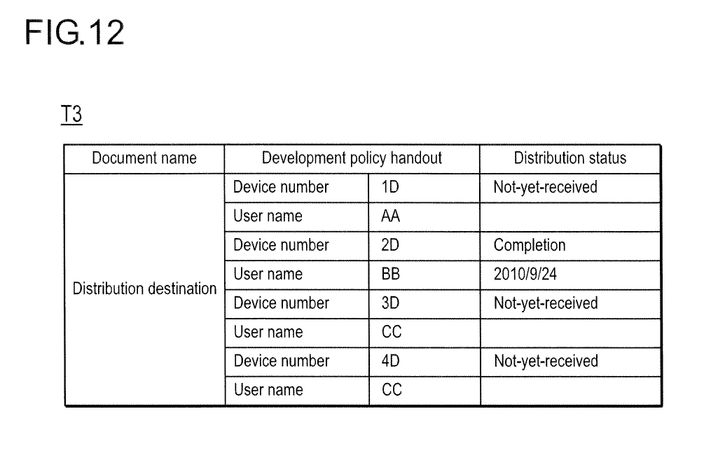

FIG. 10 is a schematic illustration showing the registration information management table T1 according to an embodiment of the present invention. As shown in this illustration, the registration information management table T1 stores the device ID, the user ID, and the viewing restriction ID of each electronic paper device 1 as well as various kinds of user registration information such as employee number, e-mail address, and authentication information. The contents of the registration information management table T1 can be arbitrarily updated by an administrator of the server 3. FIG. 12 is a schematic illustration showing the distribution status management table T3 according to an embodiment of the present invention. As shown in this illustration, the distribution status management table T3 stores information on the distribution status of the document data to each electronic paper device 1 (“Completed” or “Not-yet-received”). The contents of the distribution status management table T3 can be continually updated in response to a notice from the MFP2 and other devices.

The display unit 33 is a display device such as LCD for displaying various kinds of information to the administrator of the server 3. The operating unit 34 is an input device such as a keyboard and a mouse for receiving various kinds of operational instructions from the administrator of the server 3. For example, the operating unit 34 receives the administrator's instruction to update the user registration information (e.g. viewing restriction ID) in the registration information management table T1. The communication interface 35 is a communication module such as NIC for executing communication processing with the MFP 2 and other network devices via the network N.

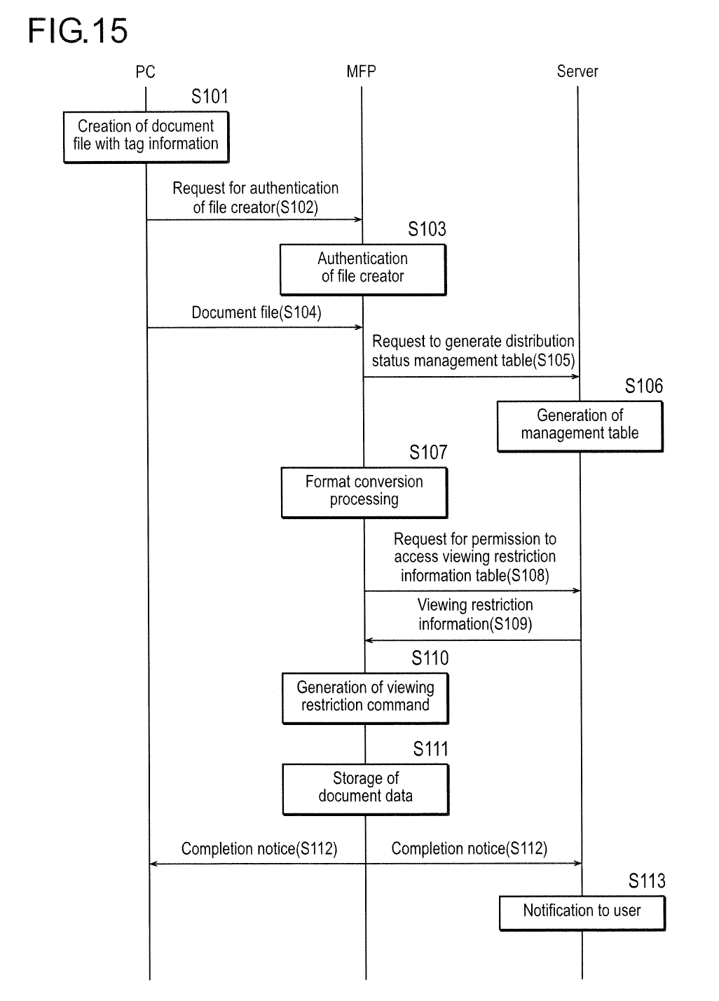

The following is an outline of the operations of the display system S according to the present embodiment. FIG. 15 is a sequence chart of the display system S according to the present embodiment showing the steps of the processing executed by the PC 4, the MFP 2, and the server 3 when the document data is generated by the MFP 2.

Referring to FIG. 15, the PC 4 first creates a document file provided with tag information as shown in FIG. 8 or FIG. 9, using various document preparation applications (S101). After that, an authentication request of the file creator is sent from the PC 4 to the MFP 2 together with the authentication information of the file creator of the document file (S102).

Upon receiving the authentication request, the MFP 2 determines whether or not the file creator should be authorized by checking the received authentication information with a predefined authentication information list (S103). The authentication information list referred to in S103 is stored in the electronic information retaining unit 22 in advance, but it can also be acquired from the server 3 each time the authentication processing is commenced.

If the file creator is authorized in the authentication processing, the document file created in S101 and distribution destination information indicating the distribution destination of the created document file are sent from the PC 4 to the MFP 2 (S104). The distribution destination information of the document file can be any kind of information that can allow the server 3 to determine the distribution destination (i.e. electronic paper device 1) of the relevant document file, and such information as the device ID and the user ID of the electronic paper device 1 can be used as the distribution destination information. The distribution destination information can be sent after the format conversion processing by the MFP 2 (S107) instead of being sent in S104.

Then, a request to generate the distribution status management table T3 for the document file created in S101 is sent from the MFP 2 to the server 3 in response to the MFP 2's receipt of the document file (S105). In this step, information on the document file such as the document name and the distribution destination information is sent together with the request to generate the distribution status management table T3. Upon receiving the request, the server 3 generates the distribution status management table T3 as shown in FIG. 12 for the document file created in S101 (S106).

The MFP 2 then execute the format conversion processing of the document file received in S104 in order to generate the document data to be handled by the electronic paper device 1 (S107). After that, a request for permission to access the viewing restriction information table T2 is sent from the MFP 2 to the server 3 (S108), and the viewing restriction information table T2 is sent from the server 3 to the MFP 2 in response to the server 3's receipt of the request for permission (S109)

The MFP 2 then translates the tag information (i.e. viewing restriction level) of the document file received in S104 into the viewing restriction ID, according to the viewing restriction information table T2 received in S109, in order to generate the viewing restriction commands as shown in FIG. 13 and FIG. 14 (S110). The MFP 2 incorporates the viewing restriction commands generated in S110 into the document data generated in S107, and then stores the document data after the incorporation of the viewing restriction commands, into the document data retaining unit (S111).

A completion notice of the document data generation is then sent from the MFP 2 to both of the PC 4 and the server 3 (S112). Upon receiving the completion notice sent in S112, the server 3 transfers the completion notice via e-mail to the users of the electronic paper devices 1 identified from the distribution destination information (S113)

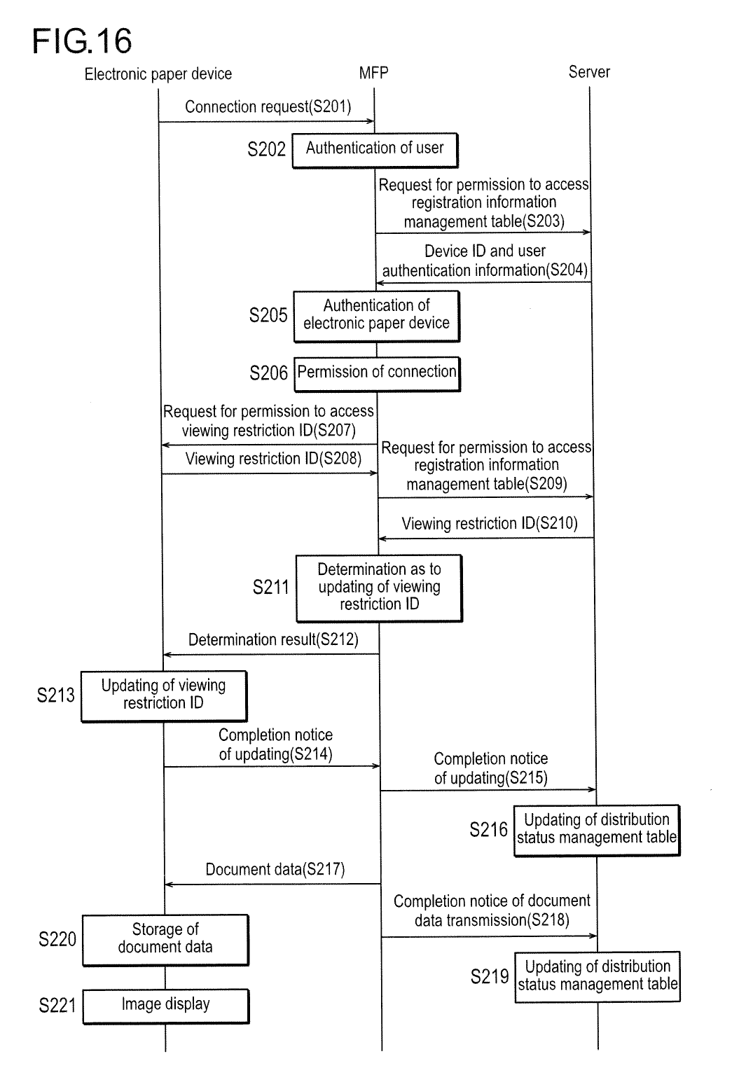

FIG. 16 is a sequence chart of the display system S according to the present embodiment showing the steps of the processing executed by the electronic paper device 1, the MFP 2, and the server 3 when an output image of the document data is displayed by the electronic paper device 1.

With reference to FIG. 16, when the electronic paper device 1 is physically connected to the MFP 2 via USB, etc., a connection request is sent from the electronic paper device 1 to the MFP 2 together with the device ID (S201). In this step, the user authentication information of the relevant electronic paper device 1 obtained by the operating unit 15 is also sent to the MFP 2.

Upon receiving the connection request and the device ID in S201, the MFP 2 determines whether or not the user of the electronic paper device 1 should be authorized by checking the received authentication information with the authentication information list retained in the electronic information retaining unit 22 (S202). If the user of the electronic paper device 1 is authorized, a request for permission to access the registration information management table T1 for the relevant electronic paper device 1 is sent from the MFP 2 to the server 3 (S203), and a combination of the device ID and the user authentication information stored in the registration information management table T1 for the relevant electronic paper device 1 is sent from the server 3 to the MFP 2 in response to the server 3's receipt of the request for permission (S204).

After that, the MFP 2 determines whether or not the relevant electronic paper device 1 should be authorized by checking the combination of the device ID and the user authentication information received in S201 with the same data combination received in S204 (S205). If the electronic paper device 1 is authorized, the MFP 2 permits connection of the electronic paper device 1 to the MFP 2 (S206).

Next, a request for permission to access the viewing restriction ID is sent from the MFP 2 to the electronic paper device 1 (S207), and the viewing restriction ID is sent from the electronic paper device 1 to the MFP 2 in response to the electronic paper device 1's receipt ion of the request for permission (S208). After that, a request for permission to access the registration information management table T1 for the relevant electronic paper device 1 is sent from the MFP 2 to the server 3 (S209), and the viewing restriction ID stored in the registration information management table T1 for the relevant electronic paper device 1 is sent from the server 3 to the MFP 2 in response to the server 3's receipt of the request for permission (S210).

Next, the MFP 2 determines whether or not the viewing restriction ID stored in the server 3 (in the registration information management table T1) has been updated by comparing the viewing restriction ID received in S208 and the viewing restriction ID received in S210 (S211). The determination result in S211 is then sent from the MFP 2 to the electronic paper device 1 (S212). More specifically, if the determination in S211 results in discrepancy between the viewing restriction IDs, the updated viewing restriction ID received in S210 (hereinafter called “updated ID”) is sent together with a notification to update the viewing restriction ID retained in the electronic paper device 1. On the other hand, if the determination in S211 results in coincidence between the viewing restriction IDs, a notification not to update the viewing restriction ID retained in the electronic paper device 1 is sent.

Next, the electronic paper device 1 updates the viewing restriction ID retained in the electronic information retaining unit 12, in response to the received notification in S212 (S213). More specifically, if a notification to update the viewing restriction ID is sent together with the updated ID in S212, the electronic paper device 1 updates the viewing restriction information ID retained in the electronic information retaining unit 12 with updated ID. On the other hand, if a notification not to update the viewing restriction ID in sent in S212, the electronic paper device 1 skips S213.

Next, when the electronic paper device 1 finishes updating the viewing restriction ID in S213, a completion notice of the updating is sent from the electronic paper device 1 to the MFP 2 (S214). This completion notice is transferred from the MFP 2 to the server 3 (S215). The server 3 then updates the distribution status management table T3 in response to the completion notice transferred in S215 (S216).

Next, the document data as shown in FIG. 13 and FIG. 14 is sent from the MFP 2 to the electronic paper device 1 (S217), and a completion notice of the document data transmission is sent from the MFP 2 to the server 3 (S218). The server 3 then updates the distribution status management table T3 in response to the completion notice of the document data transmission sent in S218 (S219).

Upon receiving the document data sent in S217, the electronic paper device 1 stores the document data into the document data retaining unit 13 (S220). After that, the electronic paper device 1 displays an image based on the document data retained in the document data retaining unit 13 on the display unit 14 (S221). In this step, the electronic paper device 1 refers to the viewing restriction ID associated with each component (i.e. object or page) within the viewing restriction commands, and then permits viewing of those components with the viewing restriction IDs smaller than the viewing restriction ID retained in the electronic information retaining unit 12 while restricting viewing of those components with the viewing restriction IDs being equal to or larger than the viewing restriction ID retained in the electronic information retaining unit 12.

As can be seen from the above, the display system S according to the present embodiment is equipped with the server 3 which can offer centralized control of the viewing restriction ID indicating the viewing restriction applicable to each electronic paper device 1, thereby ensuring that if the stored data in the server 3 of the viewing restriction ID associated with each electronic paper device 1 is revised, the updated ID indicating the viewing restriction ID after the updating will be set from the server 3 for the automatic updating of the viewing restriction ID retained data in the relevant electronic paper device 1.

Therefore, the present embodiment can ensure that each electronic paper device 1 can restrict viewing of the display image according to the viewing restriction after the updating, and therefore save the trouble of repeating generation and distribution of the image data to be displayed even when the viewing restriction applicable to each electronic paper 1 is updated by the administrator. Consequently, the present embodiment can effectively prevent the excessive system load caused by the updating of the viewing restriction applicable to each electronic paper device 1.

The present invention shall not be limited by the embodiment described above but rather it can be modified in a various way within the claims. For example, the aforementioned embodiment assumes that the electronic paper device 1 adopts the electrophoresis display method, but the display device according to the present invention can also adopt other display methods such as the micro-capsule method, the electronic powder fluid method, the liquid crystal method, the electro-wetting method, and the chemical reaction method, etc. Unlike the aforementioned embodiment in which each electronic paper device 1 is locally connected to the MFP 2, the display device according to the present invention can be connected to other devices via a network.

Moreover, the display system according to the present invention can be implemented by a dedicated hardware circuit for executing the aforementioned processing, or a program executed by a CPU to perform the aforementioned processing. If the present invention is implemented by the latter means, the control program of the display system can take a form of a computer readable recording medium such as a floppy (registered trademark) disk or CD-ROM, or a downloadable program file supplied on-line via a network such as Internet. In the former case, the program recorded on the computer readable recording medium is normally transferred to a memory unit such as a ROM or a HDD. The control program can also take a form of an application software program or a built-in function of the display system.

What is claimed is:

1. A display system comprising: a plurality of display devices for displaying an image based on document data, each of said display devices being subject to a viewing restriction of each component of said document data; and an information management device for managing viewing restriction information indicating said viewing restriction applicable to each of said display devices, wherein
said information management device comprises: a viewing restriction information storage unit for storing said viewing restriction information associated with each of said display devices; a first updating unit for updating stored content in said viewing restriction information storage unit of said viewing restriction information associated with each of said display devices according to instruction from administrator of said information management device; and an updated information sending unit for sending updated information indicating said viewing restriction information after being updated by said first updating unit,
each of said display devices comprises: a viewing restriction information retaining unit for retaining said viewing restriction information associated with each of said display devises; a viewing restriction unit for restricting viewing of each component of said image to be displayed on each of said display devices, according to said viewing restriction information retained in said viewing restriction information retaining unit; an updated information receiving unit for receiving said updated information associated with each of said display devices sent from said updated information sending unit; and a second updating unit for updating said viewing restriction information retained in said viewing restriction information retaining unit, with said updated information received by said updated information receiving unit.

2. The display system claimed in claim 1, wherein
said information management device further comprises: an administrator authentication unit for determining whether or not administrator of said information managing device should be authorized, and
said first updating unit updates said viewing restriction information according to instruction from administrator that has been authorized by said administrator authentication unit.

3. The display system claimed in claim 1, further comprising:
a data processing device comprising: a data generation unit for generating said document data based on a document file received from an external device; an user authentication unit for determining whether or not user of each of said display devices should be authorized; and a data sending unit for sending said document data to each of said display devices if user of each of said display devices has been authorized by said user authentication unit.

4. The display system claimed in claim 3, wherein
said data processing device further comprises: a display device authentication unit for determining whether or not each of said display devices should be authorized; and an updated information transferring unit for transferring said updated information associated with each of said display devices that have been authorized by said display device authentication unit, among said updated information sent by said updated information sending unit, and
said updated information receiving unit receives said updated information transferred from said updated information transferring unit.

5. The display system claimed in claim 4, wherein
said information management device further comprises: an identification information storage unit for storing combination of device identification information unique to each of said display devices and user authentication information of each of said display devices,
each of said display devices further comprises: an identification information retaining unit for retaining combination of said device identification information unique to each of said display devices and user authentication information input by user of each of said display devices, and
said display device authentication unit determines that each of said display devices should be authorized when said combination stored in said identification information storage unit coincides with said combination retained in said identification information retaining unit.

6. The display system claimed in claim 3, wherein
said data processing device further comprises: an external device authentication unit for determining whether or not said external device should be authorized; and a file receiving unit for receiving said document file from said external device that has been authorized by said external device authentication unit.

7. The display system claimed in claim 1, wherein
each of said display devices further comprises: a communication unit for establishing communication with said information management device, and
said updated information receiving unit receives said updated information sent from said updated information sending unit via said communication established by said communication unit.

8. The display system claimed in claim 1, wherein
said viewing restriction information associated with each of said display devices is determined according to an user attribute of each of said display devices.

9. The display system claimed in claim 1, wherein
said component of said document data is object or page contained in said document data.

10. The display system claimed in claim 1, wherein
said display device is an electronic paper device.

11. A display method performed by a display system comprising: a plurality of display devices for displaying an image based on document data, each of said display devices being subject to a viewing restriction of each component of said document data; and an information management device for managing viewing restriction information indicating said viewing restriction applicable to each of said display devices, wherein
said display method comprises the steps performed by said information management device of:
(a) storing said viewing restriction information associated with each of said display devices;
(b) updating stored content in said step (a) of said viewing restriction information associated with each of said display devices according to instruction from administrator of said information management device; and
(c) sending updated information indicating said viewing restriction information after being updated in said step (b), and
said display method further comprises the steps performed by each of said display devices of:
(d) retaining said viewing restriction information associated with each of said display devises;
(e) restricting viewing of each component of said image to be displayed on each of said display devices, according to said viewing restriction information retained in said step (d);
(f) receiving said updated information associated with each of said display devices sent in said step (c); and
(g) updating said viewing restriction information retained in said step (d), with said updated information received in said step (f).

12. The display method claimed in claim 11, further comprising the step performed by said information management device of:
(h) determining whether or not administrator of said information managing device should be authorized, wherein
said step (b) updates said viewing restriction information according to instruction from administrator that has been authorized in said step (h).

13. The display method claimed in claim 11, further comprising the steps performed by a data processing device of:
(i) generating said document data based on a document file received from an external device;
(j) determining whether or not user of each of said display devices should be authorized; and
(k) sending said document data to each of said display devices if user of each of said display devices has been authorized in said step (j).

14. The display method claimed in claim 13, further comprising the steps performed by said data processing device of:
(l) determining whether or not each of said display devices should be authorized; and
(m) transferring said updated information associated with each of said display devices that have been authorized in said step (l) among said updated information sent in said step (c), wherein
said step (f) receives said updated information transferred in said step (m).

15. The display method claimed in claim 14, further comprising the step performed by said information management device of:
(n) storing combination of device identification information unique to each of said display devices and user authentication information of each of said display devices, and
further comprising the step performed by each of said display devices of:
(o) retaining combination of said device identification information unique to each of said display devices and user authentication information input by user of each of said display devices, wherein
said step (l) determines whether or not each of said display devices should be authorized when said combination stored in said step (n) coincides with said combination retained in said step (o).

16. The display method claimed in claim 13, further comprising the steps performed by said data processing device of:
(p) determining whether or not said external device should be authorized; and
(q) receiving said document file from said external device that has been authorized in said step (p).

17. The display method claimed in claim 11, further comprising the step performed by each of said display devices of:
(r) establishing communication with said information management device, wherein
said step (f) receives said updated information sent in said step (c) via said communication established in said step (r).

18. The display method claimed in claim 11, wherein
said viewing restriction information associated with each of said display devices is determined according to an user attribute of each of said display devices.

19. The display method claimed in claim 11, wherein
said component of said document data is object or page contained in said document data.

20. The display method claimed in claim 11, wherein
said display device is an electronic paper device.
